(19) United States
(12) Patent Application Publication
(10) Pub. No.: US 2026/0099974 A1
(43) Pub. Date: Apr. 9, 2026

(54) PERSONALIZED REALISTIC VIDEO GENERATION

(71) Applicant: Zoom Communications, Inc., San Jose, CA (US)

(72) Inventors: Yuanqi Chen, Hangzhou (CN); Yuhui Chen, San Jose, CA (US); Dewang Hou, Hangzhou (CN); Bo Ling, Saratoga, CA (US); Gengdai Liu, Singapore (SG); Liubin Liu, Pleasanton, CA (US); Matthieu Tardivel, Montpellier (FR); Rui Zhang, Pleasanton, CA (US); Yian Zhu, San Jose, CA (US)

(73) Assignee: Zoom Video Communications, Inc., San Jose, CA (US)

(21) Appl. No.: 18/968,320

(22) Filed: Dec. 4, 2024

(30) Foreign Application Priority Data
Oct. 8, 2024 (CN) 202411393333.5

(51) Int. Cl. G06T 13/20; G06V 10/774

(52) U.S. Cl. CPC G06T 13/205; G06V 10/774

(57) ABSTRACT

Systems and methods for personalized realistic video generation. In one example, a client device joins a video conference. The client device accesses a source video clip including a set of source video frames related to a user associated with the client device. The client device receives source audio data related to the user. The client device generates target video data based on the set of source video frames and the source audio data using a trained video generator model. The client device streams the target video data during the video conference.

### REFERENCE TO RELATED APPLICATION

This claims the benefit of priority under 35 U.S.C. § 119(a) to Chinese Patent Application No. 202411393333.5, filed Oct. 8, 2024, the entirety of which is hereby incorporated by reference herein.

### FIELD

The present application generally relates to video synthesis and more specifically relates to personalized realistic video generation.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices;

FIG. 2 shows an example system in which a chat and video conference provider provides chat and videoconferencing functionality to various client devices;

FIG. 3 shows an example system that can establish a virtual communication session;

FIG. 4 shows an example system that is configured for personalized realistic video generation;

FIG. 5 shows an example GUI displaying a consent authorization request for accessing personal data;

FIG. 6 shows an example process for personalized realistic video generation;

FIG. 7 shows an example process for training a video generator model for personalized realistic video generation;

FIG. 8 shows an example computing device suitable for use with example systems and methods for personalized realistic video generation.

### DETAILED DESCRIPTION

Examples are described herein in the context of personalized realistic video generation. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferences and video content have become a common way for people to interact and obtain information. People can be invited to a video conference, join from their personal computers or telephones, and are able to see and hear each other and converse largely as they would during an in-person group meeting or event. In some instances, a participant may not want to show his or her real appearance, or does not want to use his or her own voice to speak. For appearance, the participant can use a 3-dimensional (3D) virtual character (e.g., avatar) to reflect the head movements and facial expressions of the participant, without showing the real face of the participant. For voice, the participant can use a text-to-speech (TTS) model to generate speech. However, appearance generation and voice cloning based on existing approaches lack naturalness and personalization, other participants or audience can easily tell that the generated video is artificial, which negatively affects user experience and general adoption. Thus, there is a need to provide personalized realistic video generation.

In order to provide personalized realistic video generation, a generative artificial intelligence (AI) model is trained with personalized video data and used to generate realistic video content. For example, a generative adversarial network (GAN) is used to train a personalized video generation engine based on a recorded video of a user speaking to generate synthetic videos of that user speaking based on a provided audio of the user's speech.

The personalized video generation engine is provided by a service provider server and trained or customized for a particular user using the user's own recorded video. The training video is pre-recorded and can be a few minutes long, for example 4-5 minutes. The visual part of the video includes the user's head, and may also include neck and part of the torso. The audio part of the video includes the user speaking or reading out loud using his or her natural voice in his or her natural manner. In addition, the user also be required to provide their explicit consent within the video to create the personalized video generation engine. They may also be required to speak certain randomly generated information, such as a randomly generated alpha-numeric sequence, to confirm it is the user who is speaking.

The personalized video generation engine uses or implements an autoencoder, that is trained to encode and decode both video images and audio To train the personalized video generation engine, the engine uses the autoencoder to extract image features (e.g., facial features such as eye brow features, eye features, nose features, lip features, cheek features, etc.) from the training video data and project them into a latent space to generate latent image features. Meanwhile, the audio encoder extracts voice features from the training video data and projects the voice features into the latent space to generate latent voice features. The latent voice features and the latent image features can be mapped together in the latent space so that certain image features correspond to certain audio features. The autoencoder can then re-generate the original video by decoding the image features and the audio features from the latent space, respectively. A discriminator is used to determine whether the regenerated video and audio is authentic or not and to adjust certain parameters of the autoencoder. The training process is repeated until the discriminator is sufficiently unable to determine whether the regenerated video is authentic or synthetic. Thus, the personalized video generation engine can be trained to generate personalized videos of the user based on the features stored in the latent space.

During inference, the user provides an audio clip and a template video to the personalized video generation engine. The template video depicts the user speaking, which can be several seconds long, for example 10 seconds or 20 seconds. The audio clip can be generated by a TTS model using the user's voice or pre-recorded by the user. The text provided to the TTS model for audio generation can be any suitable text that the user wishes to use to provide synthetic audio for a personalized video, such as a script or presentation. The personalized video generation engine generates video frames based on the latent image features in the latent space and the user speaking within the audio clip as the input. The personalized video generation engine is thus able to generate a video of the user uttering the audio in the audio clip.

Thus, the personalized video generation engine generates personalized realistic video for the user to participate in video conferences or provide pre-generated videos using transformer-based autoencoders. The personalized video generation engine can be installed on a client device associated with a user and customized for the user. The personalized video generation engine can be used in live communication or to generate videos on demand.

This illustrative example is given to introduce the reader to the general subject matter discussed herein and the disclosure is not limited to this example. The following sections describe various additional non-limiting examples and examples of personalized realistic video generation.

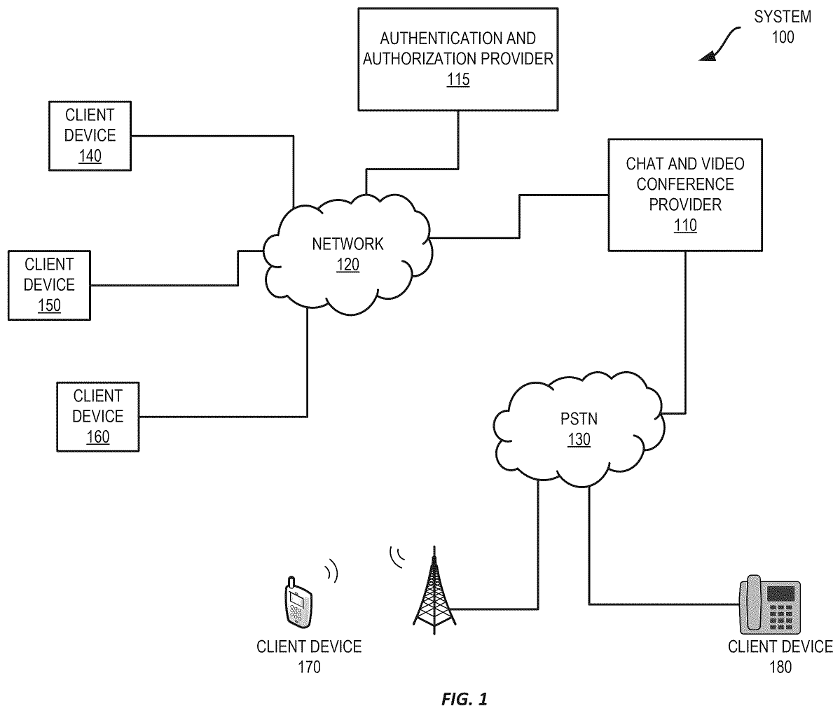

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

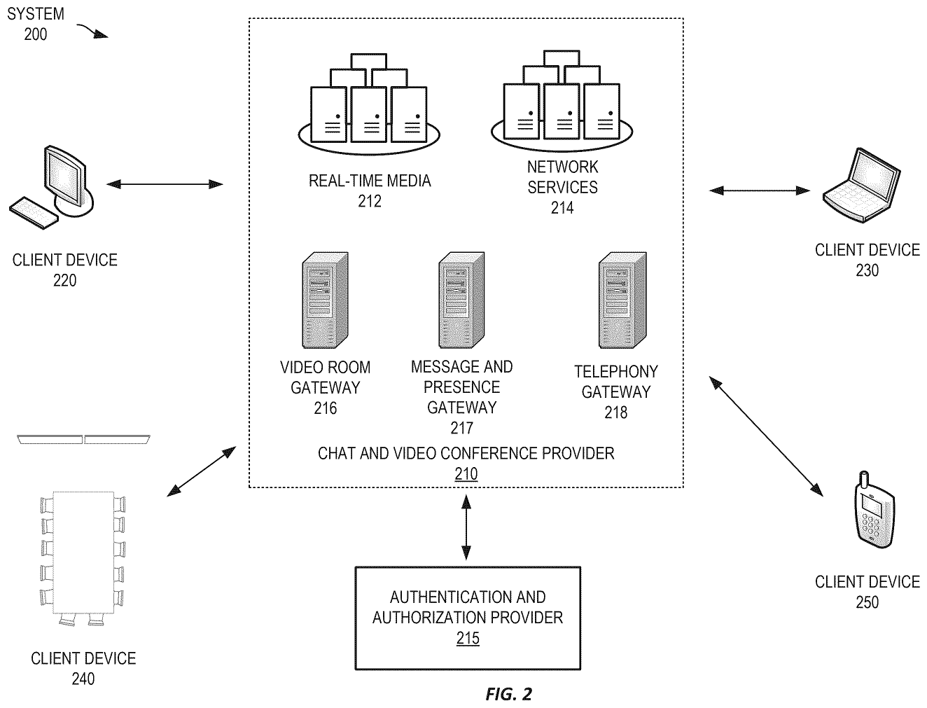

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

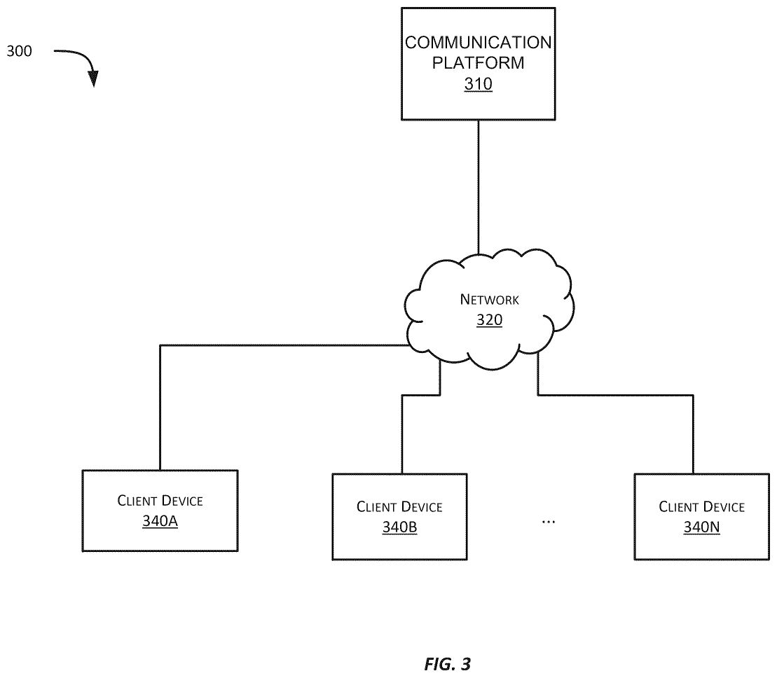

Referring now to FIG. 3, FIG. 3 shows an example system 300 that can establish a virtual communication session. In this example system 300, a communication platform 310 and a number of client devices 340A-340N (which may be referred to herein individually as a client device 340 or collectively as the client devices 340) are connected via a network 320. The communication platform 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANS, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

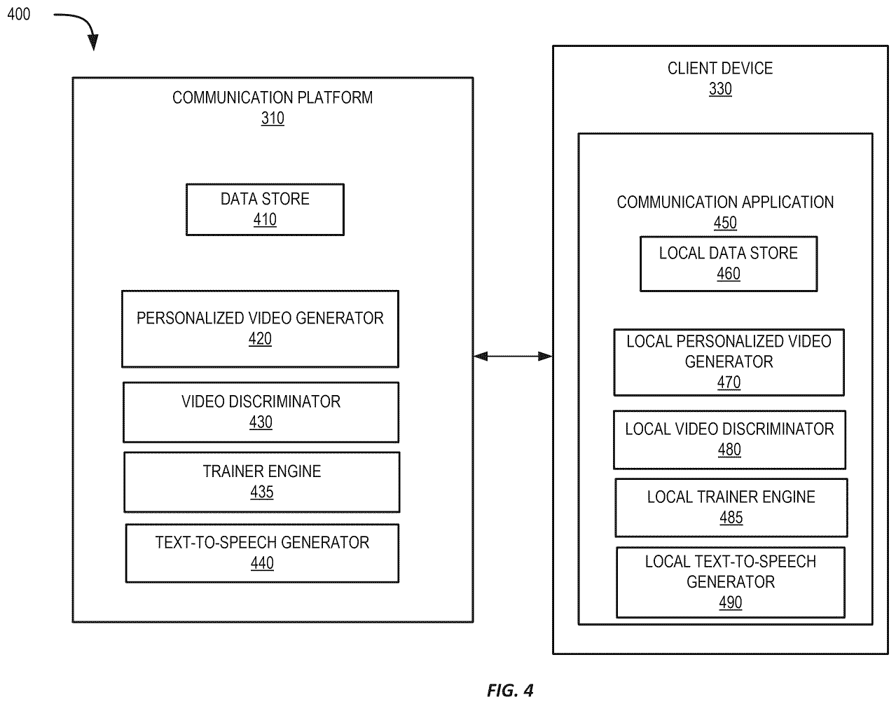

Referring now to FIG. 4, FIG. 4 shows an example system that is configured for personalized realistic video generation. The communication platform 310 is in network communication with a client device 330. The communication platform 310 includes a data store 410, a personalized video generator 420, a video discriminator 430, a trainer engine 435, and a text-to-speech (TTS) generator 440.

The data store 410 stores training video data associated with specific users, source audio data and source video clips used for generating target personalized realistic videos for the corresponding specific users. The data store 410 also stores text inputs and speaker information used for generating the source audio data. In some examples, the data store 410 also stores some intermediate datasets, for example training image features extracted from the training video data and encoded in a latent space, training audio features extracted from the training video data, facial images generated corresponding to the source audio data for the corresponding specific users, predictions by the video discriminator 430, or digital assets for customizing an appearance of a user in a generated video clip, which will be described in detail below.

The personalized video generator 420 is configured to generate personalized realistic videos. The personalized video generator 420 includes a machine learning model for personalized realistic video generation, for example an autoencoder or a GAN. The machine learning model can include one or more encoder models and one or more decoder models, for example an image encoder-decoder pair and an audio encoder-decoder pair. The encoders and decoders use, implement, or include transformer models or convoluted neural networks (CNNs) or any other suitable deep learning networks.

The personalized video generator 420 is trained, tailored, or customized for a specific user using training video data associated with the specific user. The training video data includes a set of training video frames and corresponding training audio data. The set of training video frames, which is the visual part of the training video data, depict the user's head, and may also include neck and part of the torso. The training audio data, which is the audio part of the training video data, includes the user speaking or reading out loud using his or her natural voice in his or her natural manner.

In some examples, the personalized video generator 420 is trained in a generative adversarial network framework, which includes the personalized video generator 420 and the video discriminator 430. During training, the personalized video generator 420 encodes the set of training video frames to obtain a set of training image features (e.g., feature embeddings) in a latent space using an encoder model (e.g., an image encoder). The set of training image features may include eyebrow features, eye features, noise features, lip features, cheek features eye movement features, or head movement features. In some examples, the set of training image features may include mouth region features, such as lip movement features and cheek movement features.

The personalized video generator 420 also uses an audio encoder to extract a set of training audio features from the training audio data. The personalized video generator 420 maps the set of training audio features to the set of training image features in the latent space to generate a set of training alignment features.

The personalized video generator 420 reconstructs the training video data by decoding the set of training alignment features using one or more decoder models to obtain a reconstructed or synthesized training video data. In some examples, an image decoder decodes the set of training image features including image features of the entire head and renders a set of synthesized training video frames using a rendering algorithm. In some examples, the image decoder decodes mouth region features to obtain a set of synthesized mouth region images. The personalized video generator 420 synchronizes the set of synthesized training video frames or the set of synthesized mouth region images with the training audio data to obtain reconstructed or synthesized training video data.

Alternatively, or additionally, the personalized video generator 420 uses an audio decoder to decode the set of training audio features to obtain synthesized audio data as reconstructed training audio data. The set of synthesized training video frames or the set of synthesized mouth region images are synchronized with the synthesized audio data to obtain reconstructed or synthesized training video data.

The video discriminator 430 is pre-trained to differentiate between the original training video data and the reconstructed training video data. In some examples, the video discriminator 430 includes an image discriminator for distinguishing synthesized training video frames and the original training video frames. The image discriminator extracts image features from randomly received video frames and generates a prediction indicating whether the extracted image features are from the synthesized training video frames or the original training video frames.

The video discriminator 430 also includes an audio discriminator for distinguishing the reconstructed training audio data and the original training audio data. The audio discriminator extracts audio features from randomly received audio data and generates a prediction indicating whether the extracted audio features are from the reconstructed audio data or the original training audio data. In some examples, the audio features include acoustic features (e.g., pitch, energy, and duration) and prosodic features (e.g., rhythm, stress, and intonation). The audio discriminator further includes an acoustic discriminator and a prosodic discriminator. The acoustic discriminator generates a prediction indicating whether the extracted acoustic features are from the reconstructed audio data or the original training audio data. The prosodic discriminator generates a prediction indicating whether the extracted prosodic features are from the reconstructed audio data or the original training audio data.

During training, the personalized video generator 420 tries to reconstruct training video data that the image discriminator or the audio discriminator cannot distinguish from the original training video data, while the image discriminator and the audio discriminator try to get better at differentiating training video data from the synthesized data. This adversarial process leads to the personalized video generator 420 creating increasingly better video data over time.

The trainer engine 435 includes an optimization algorithm, for example an Adam optimizer. The optimization algorithm minimizes a loss function including generator losses associated with the reconstructed training video data (e.g., a generator loss related to reconstructed training video frames and a generator loss related to reconstructed training audio data) and adversarial loss associated with the predictions of the video discriminator (e.g., an adversarial loss related to the image discriminator and an adversarial loss related to the audio discriminator) to obtain optimized parameters for the encoders and decoders in the personalized video generator 420. The trainer engine 435 iterates the training process as described above until the loss function converges. In some examples, the communication platform 310 transmits a personalized video generator 420 trained for a specific user to a client device 340 associated with the specific user. In some examples, the communication platform 310 includes multiple personalized video generators 420 for corresponding specific users.

In some examples, the communication platform 310 also includes a TTS generator 440 pre-trained to generate source audio data based on text input and speaker information corresponding to a specific user. The TTS generator 440 includes a pre-trained acoustic model and a vocoder. The acoustic model includes a synthesizer encoder pretrained to generate phoneme hidden sequence and a synthesizer decoder pretrained to convert the phoneme hidden sequences into spectrogram sequences. The vocoder generates audio waveforms based on the spectrogram to provide the source audio data.

Once trained, the personalized video generator 420 can then generate personalized video data based on a source video clip and source audio data that appears as though the user is actually speaking the words contained in the source audio data. The source video clip is pre-recorded by the specific user with authentication. For example, the user is required to read a randomly generated code (e.g., numerals, characters, or combined) during the recording to be linked with identification to prevent deepfake. The source video clip is a personalized realistic avatar representing a specific user. In some examples, the source video clip is a video segment selected from the training video data.

The personalized video generator 420 generates a set of video frames that include facial images using an image decoder based on the training image features in the latent space and the source audio data. In some examples, the personalized video generator 420 masks out the mouth region of the video frames in the source video clip. The personalized video generator 420 extracts a set of mouth region images from the set of facial images generated by the image decoder to combine with the masked-out video frames in the source video clip, using a rendering algorithm, and then synchronizes with the source audio data to obtain target video data. In some examples, the source video clip is several seconds long (e.g., 10 seconds, 20 seconds). The source audio data can be longer than the source video clip, in which case, the source video clip may be restarted once all video frames have been used. This may occur multiple times, depending on the length of the source audio data. During the rendering, the successive video frames of the source video clip are used iteratively for generating the target video data synchronized with the source audio data.

In some examples, the input to the personalized video generator 420 only includes source audio data. The personalized video generator 420 then generates video frames based on the source audio data and the image and audio features encoded in the latent space to obtain synthetic video frames.

In some examples, the source audio data is generated in real time by the TTS generator 440 based on user input in a live video conference. In some examples, the source audio data is pre-recorded or pre-generated by the TTS generator 440 based on a text script. In some examples, the source audio data is from live uttering by the user in the video conference. The generated target video data can be streamed in a live video conference or stored as a video clip and provided to target audiences asynchronously, such as a training video or presentation on demand.

In some examples, before the target video data is being streamed or stored, a user customizes the appearance of the user in the video frames. For example, a user can select a specific hair style, beard style, eyeglass style, makeup, jewelry, scarf, clothes, or other suitable accessories. These accessory models are stored in the data store as digital assets. Alternatively, or additionally, the user provides a description of a specific accessory, a generative model in the personalized video generator 420 modifies or customizes the generated target video data based on the description.

The client device 340 is installed with a communication application 450 provided by the communication platform 310. In some examples, the communication application 450 installed on the client device 340 includes a local data store 460, a local personalized video generator 470, a local video discriminator 480, a local trainer engine 485, and a local TTS generator 490.

The local data store 460 stores local data associated with training the local personalized video generator 470 or generating personalized videos. For example, the local data store 460 stores training video data depicting a local user associated with the client device 340. The local data store 460 also stores source video clip (e.g., personalized realistic avatar) and source audio data as inputs to the local personalized video generator 470, and target video data as outputs of the local personalized video generator 470.

In some examples, the local personalized video generator 470 is trained on the communication platform 310 and provided to the client device 340. In some examples, the local personalized video generator 470 is trained locally on the client device 340. The communication application 450 also includes a local video discriminator 480, which forms a generative adversarial network framework with the local personalized video generator 470 for training the local personalized video generator 470, similar to the video discriminator 430 on the communication platform 310. The local trainer engine 485 optimizes a loss function including generator losses and adversarial losses to adjust parameters of the local personalized video generator 470, similar to the trainer engine 435 on the communication platform 310.

The communication application 450 also includes a local TTS generator 490 configured to generate synthesized audio data as source audio data based on text input and speaker information of the local user associated with the client device 340, similar to the TTS generator 440 on the communication platform 310. The communication application 450 also includes graphical user interface (GUI) for hosting or joining a video conference. The GUI also includes an input box for the local user to type or enter text input for converting to audio data.

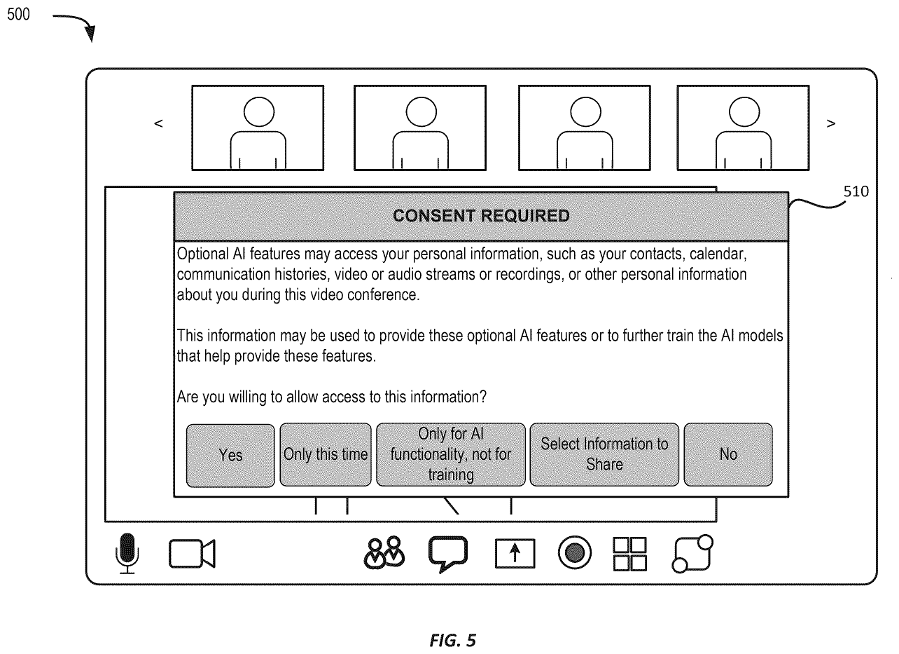

Referring now to FIG. 5, FIG. 5 shows an example GUI 500 displaying a consent authorization request for accessing personal data. In some examples according to the present disclosure, a user may select an option to use one or more optional AI features available from a communication platform, such as the chat and video conference provider 110, the chat and video conference provider 210, or the communication platform 310. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to provide training data for the underlying AI models, the user may be provided with an option to consent, or deny consent, to access and use some or all of the user's personal information. In general, Applicant's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 5, a user has engaged in a video conference and has selected an option to use an available optional AI feature. In response, the GUI has displayed a consent authorization window 510 for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

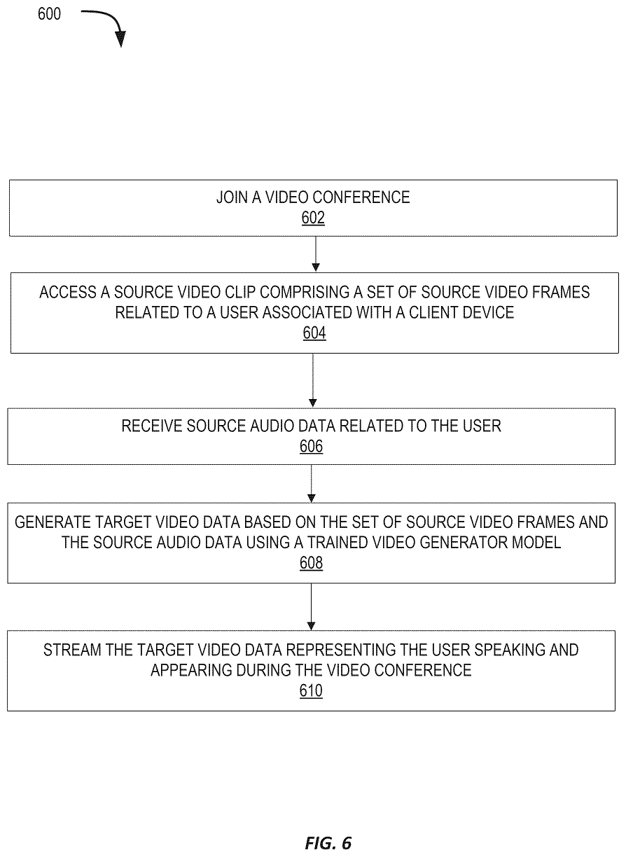

Referring now to FIG. 6, FIG. 6 shows an example process 600 for personalized realistic video generation. The example process 600 will be discussed with respect to the system 400 shown in FIG. 4; however, any suitable system for personalized realistic video generation may be used.

At block 602, a client device 340 joins a video conference. The client device 340 is installed with a communication application 450 provided by the communication platform 310. The communication application 450 includes functionalities for establishing, hosting, or joining a video conference. The video conference includes two or more participants, who can communicate via audio or video streaming. A client device 340 associated with a user joins a video conference, but the user may not be able to or choose not to show his/her face or speak using his/her own throat.

At block 604, the client device 340 accesses a source video clip comprising a set of source video frames related to a user associated with the client device 340. A participant, for example the user associated with the client device 340, selects an option for generating personalized video streams so that the participant does not have to speak or appear on the camera. The client device 340 receives the option via a user input device associated with the client device 340. In response, the local personalized video generator 470 on the client device 340 accesses a source video clip. The source video clip is usually several seconds long (e.g., 10 seconds or 20 seconds), including a set of source video frames depicting the user speaking utterances, for example speaking or reading out loud using his or her natural voice in his or her natural manner. The utterances include a unique identifier, such as a string of numerals or characters randomly generated for the user. The source video clip is a personalized template avatar for the user, it represents the user realistically. The source video clip is used for generating personalized realistic videos for the user during the video conference, as will be described below. In some examples, the mouth region of the user is masked out from the source video clip.

At block 606, the client device 340 receives source audio data related to the user. During the video conference, if a user wants to speak in the video conference, but does not want to use his voice, the user enters or types in a text script including what he wanted to say via a user input device, for example a keyboard. The local TTS generator 490 on the client device 340 receives the text script and generates the source audio data. In some examples, the local TTS generator 490 is pre-trained or customized for the user associated with the client device 340 to generate the source audio data. In some examples, the user enters the text script with one or more emotion annotations, for example an emotion description in a bracket (e.g., {excited}, {angry}). The local TTS generator 490 generates the source audio data reflecting the corresponding emotions.

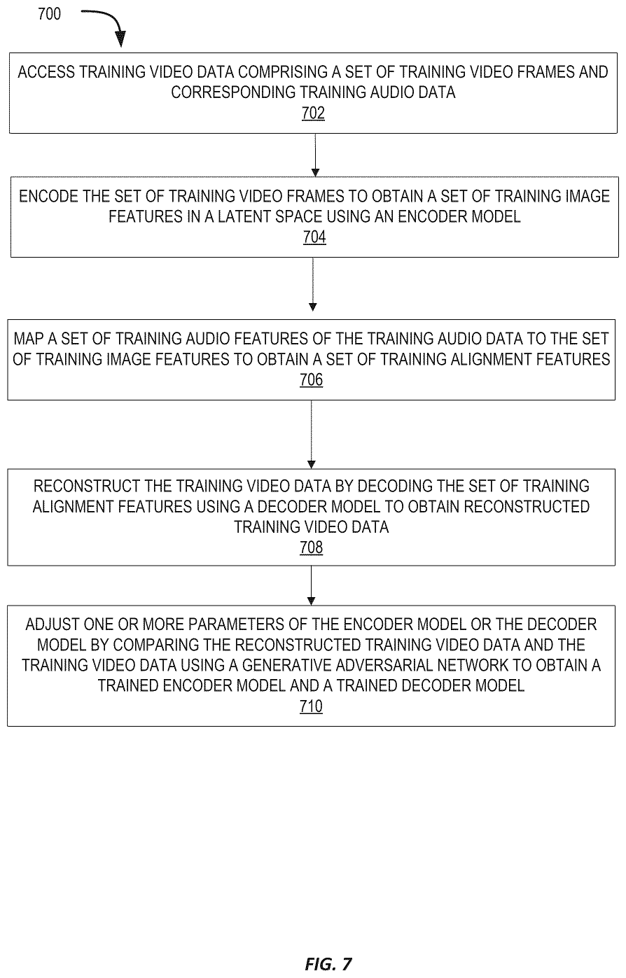

At block 608, the client device 340 generates target video data based on the set of source video frames and the source audio data using a trained video generator model. The local personalized video generator 470 on the client device 340 uses or includes a trained video generation model. The trained video generator model includes one or more encoder models and one or more decoder models, which are trained using training video data associated with the user, as will be described in FIG. 7. During training, user image features are extracted from a set of training video frames in the training video data associated the user and mapped with user audio features in a latent space to form alignment features. During implementation, the decoder model decodes the training image features based the alignment features to generate a plurality of video frames that match the source audio data. If the source audio data indicates certain emotions, the plurality of video frames include image features that reflect the corresponding emotions. In some examples, the plurality of video frames depicts the mouth region of the user, including lip movements and cheek movements. The local personalized video generator 470 renders the target video data by combining the plurality of video frames with the set of video frames in the source video clip. In some examples, the source audio data is longer than the source video clip. The source video clip is iteratively combined with the plurality of video frames to generate the target video data.

At block 610, the client device 340 streams the target video data representing the user speaking and appearing during the video conference. The client device 340 streams the target video data generated at block 608 to represent the user speaking and appearing during the video conference. The time delay from when the user enters a text script to the client device 340 streams the target video data can be less than 1 second. The time delay includes the time converting the text script to source audio data, generating the target video data, and streaming the video data. There may be additional delay caused by network issue or buffering, which is not relevant to the personalized realistic video generation techniques of the present disclosure.

The example process 600 illustrates a method for personalized realistic video generation. However, not every step in the example process 600 may be needed, some other steps may be added, or the order of the steps may be changed. Alternatively, the example process 600 can be performed by the communication platform 310.

Referring now to FIG. 7, FIG. 7 shows an example process 700 for training a video generator model for personalized realistic video generation. The example process 600 will be discussed with respect to the system 400 shown in FIG. 4; however, any suitable system for training a video generator model for personalized realistic video generation may be used.

At block 702, a client device 340 accesses training video data comprising a set of training video frames and corresponding training audio data. The training video data is usually a few minutes long (e.g., 4 minutes) playing at the normal frame rate (e.g., 24 frames per second). The training video data is pre-recorded depicting the user speaking or reading out loud utterances using his or her natural voice in his or her natural manner.

At block 704, the client device 340 encodes the set of training video frames to obtain a set of training image features in a latent space using an encoder model. An image encoder of the local personalized video generator 470 extracts or encodes a set of training image features in the latent space based on the set of training video frames. The set of training image features in the latent space are feature embeddings. In some examples, the set of training image features include facial image features. In some examples, the set of training image features include mouth region features, such as lip movement features and cheek movement features when the user is speaking.

At block 706, the client device 340 maps a set of training audio features of the training audio data to the set of training image features to obtain a set of training alignment features. In some examples, the local personalized video generator 470 also includes an audio encoder for extracting or encoding a set of training audio features based on the training audio data. The set of training audio features are mapped to the set of training image features to create a set of training alignment features.

At block 708, the client device 340 reconstructs the training video data by decoding the set of training alignment features using a decoder model to obtain reconstructed training video data. The decoder model of the local personalized video generator 470 decodes the set of training alignment features to reconstruct the training video data. In some examples, the decoder model includes an image decoder and an audio decoder. The image decoder decodes the set of training image features to reconstruct a set of training video frames, and the audio decoder decodes the set of training audio features to reconstruct the training audio data. The local personalized video generator 470 uses a rendering algorithm to reconstruct the training video data by synchronizing and combining the reconstructed training video frames and the reconstructed training audio data.

At block 710, the client device 340 adjusts one or more parameters of the encoder model or the decoder model by comparing the reconstructed training video data and the training video data using a generative adversarial network to obtain a trained encoder model and a trained decoder model. The generative adversarial network includes the local personalized video generator 470 and a local video discriminator 480. The local video discriminator 480 includes an image discriminator and an audio discriminator. The image discriminator randomly receives an original training video frame or a reconstructed training video frame and generates a prediction whether the received video frame is the original or the reconstructed. The audio discriminator randomly receives a sample of the original training audio data or a sample of the reconstructed training audio data and generates a prediction whether the received audio sample is from the original training audio data or the reconstructed training audio data. The local trainer engine 485 uses an optimization algorithm to optimize a loss function including generator losses associated with the local personalized video generator 470 and adversarial losses associated with the image discriminator and the audio discriminator of the local video discriminator 480, thereby obtaining one or more updated parameters of the encoder models or the decoder models. The local trainer engine 485 adjust the encoder models or the decoder models of the local personalized video generator 470 using the one or more updated parameters. The process 700 can be repeated for a predetermined period of time or until the loss function converges.

The example process 700 illustrates a method for training a personalized video generator for personalized realistic video generation. However, not every step in the example process 700 may be needed, some other steps may be added, or the order of the steps may be changed. Alternatively, the example process 700 can be performed by the communication platform 310.

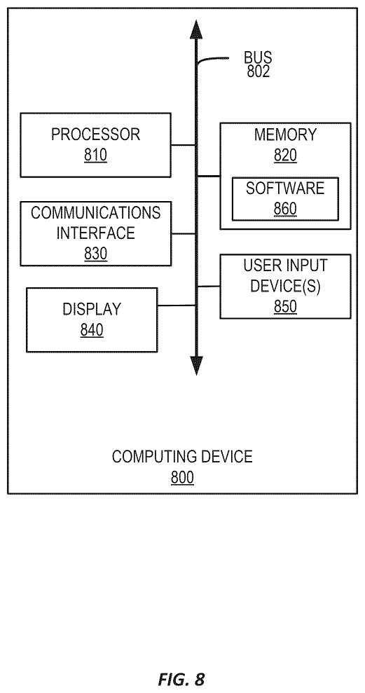

Referring now to FIG. 8, FIG. 8 shows an example computing device 800 suitable for use in example systems or methods for personalized realistic video generation. The example computing device 800 includes a processor 810 which is in communication with the memory 820 and other components of the computing device 800 using one or more communications buses 802. The processor 810 is configured to execute processor-executable instructions stored in the memory 820 to perform one or more methods associated with personalized realistic video generation according to different examples, such as part or all of the example process 600 described above with respect to FIG. 6 or part or all of the example process 700 described above with respect to FIG. 7. In some embodiments, the computing device may include software 860 for executing one or more methods described herein, such as for example, one or more steps of process 600 or process 700. The computing device 800, in this example, also includes one or more user input devices 850, such as a keyboard, mouse, touchscreen, microphone, etc., to accept user input. The computing device 800 also includes a display 840 to provide visual output to a user.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
joining, by a client device, a video conference;
accessing, by the client device, a source video clip comprising a set of source video frames related to a user associated with the client device;
receiving, by the client device, source audio data related to the user;
generating, by the client device, target video data based on the set of source video frames and the source audio data using a trained video generator model; and
streaming, by the client device, the target video data during the video conference.

2. The method of claim 1, further comprising training a video generator model comprising an encoder model and a decoder model to obtain the trained video generator model by:
accessing training video data comprising a set of training video frames and corresponding training audio data;
encoding the set of training video frames to obtain a set of training image features in a latent space using an encoder model;
mapping a set of training audio features of the training audio data to the set of training image features to obtain a set of training alignment features;
reconstructing the training video data by decoding the set of training alignment features using a decoder model to obtain reconstructed training video data; and
adjusting one or more parameters of the encoder model or the decoder model by comparing the reconstructed training video data and the training video data using a generative adversarial network to obtain a trained encoder model and a trained decoder model.

3. The method of claim 2, wherein the encoder model comprises a first transformer model, wherein the decoder model comprises a second transformer model.

4. The method of claim 2, wherein the generative adversarial network comprises the video generator model and a video discriminator, wherein the video discriminator comprises an image discriminator and an audio discriminator.

5. The method of claim 2, wherein generating the target video data based on the set of source video frames and the source audio data using the trained video generator model comprises:
generating a plurality of mouth region images for the user corresponding to the source audio data based on the set of training image features in the latent space using the trained decoder model;
blending the plurality of mouth region images with the set of source video frames respectively iteratively to generate a set of target video frames; and
synchronizing the set of target video frames and the source audio data to generate the target video data.

6. The method of claim 1, further comprising:
receiving a selection of one or more digital assets for customizing an appearance of the user in the target video data, wherein the one or more digital assets corresponds to hair style, beard style, eyeglass style, or makeup; and
generating the target video data further based on the selection of one or more digital assets.

7. The method of claim 1, wherein the source video clip comprises a pre-recorded video depicting the user speaking utterances comprising a unique identifier associated with the user, wherein the unique identifier comprising a string of numerals or characters randomly generated for the user.

8. The method of claim 1, further comprising:
receiving a text script; and
generating the source audio data based on the text script using a trained text-to-speech model.

9. The method of claim 8, further comprising receiving the text script from a user input device associated with the client device during the video conference.

10. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
join a video conference;
access a source video clip comprising a set of source video frames related to a user associated with a client device;
receive source audio data related to the user;
generate target video data based on the set of source video frames and the source audio data using a trained video generator model; and
stream the target video data during the video conference.

11. The system of claim 10, wherein the one or more processors are configured to execute further processor-executable instructions stored in the non-transitory computer-readable medium to:
train a video generator model comprising an encoder model and a decoder model to obtain the trained video generator model by:
accessing training video data comprising a set of training video frames and corresponding training audio data;
encoding the set of training video frames to obtain a set of training image features in a latent space using an encoder model;
mapping a set of training audio features of the training audio data to the set of training image features to obtain a set of training alignment features;
reconstructing the training video data by decoding the set of training alignment features using a decoder model to obtain reconstructed training video data; and
adjusting one or more parameters of the encoder model or the decoder model by comparing the reconstructed training video data and the training video data using a generative adversarial network to obtain a trained encoder model and a trained decoder model.

12. The system of claim 11, wherein the encoder model comprises a first transformer model, wherein the decoder model comprises a second transformer model, wherein the generative adversarial network comprises the video generator model and a video discriminator, and wherein the video discriminator comprises an image discriminator and an audio discriminator.

13. The system of claim 11, wherein the one or more processors are configured to execute further processor-executable instructions stored in the non-transitory computer-readable medium to generate the target video data based on the set of source video frames and the source audio data by:
generating a plurality of mouth region images for the user corresponding to the source audio data based on the set of training image features in the latent space using the trained decoder model;
blending the plurality of mouth region images with the set of source video frames respectively iteratively to generate a set of target video frames; and
synchronizing the set of target video frames and the source audio data to generate the target video data.

14. The system of claim 10, wherein the one or more processors are configured to execute further processor-executable instructions stored in the non-transitory computer-readable medium to:
receive a selection of one or more digital assets for customizing an appearance of the user in the target video data, wherein the one or more digital assets corresponds to hair style, beard style, eyeglass style, or makeup; and
generate the target video data further based on the selection of one or more digital assets.

15. The system of claim 10, wherein the source video clip comprises a pre-recorded video depicting the user speaking utterances, wherein the utterances comprise a unique identifier associated with the user, wherein the unique identifier comprising a string of numerals or characters randomly generated for the user.

16. The system of claim 10, wherein the one or more processors are configured to execute further processor-executable instructions stored in the non-transitory computer-readable medium to:
receive a text script from a user input device associated with a client device during the video conference; and
generate the source audio data based on the text script using a trained text-to-speech model.

17. A non-transitory computer-readable medium comprising processor-executable instructions configured to cause one or more processors to:
join a video conference;
access a source video clip comprising a set of source video frames related to a user associated with a client device;
receive source audio data related to the user;
generate target video data based on the set of source video frames and the source audio data using a trained video generator model; and
stream the target video data during the video conference.

18. The non-transitory computer-readable medium of claim 17, further comprising processor-executable instructions configured to cause one or more processors to:
access training video data comprising a set of training video frames and corresponding training audio data;
encode the set of training video frames to obtain a set of training image features in a latent space using an encoder model;
map a set of training audio features of the training audio data to the set of training image features to obtain a set of training alignment features;
reconstruct the training video data by decoding the set of training alignment features using a decoder model to obtain reconstructed training video data; and
adjust one or more parameters of the encoder model or the decoder model by comparing the reconstructed training video data and the training video data using a generative adversarial network to obtain a trained encoder model and a trained decoder model.

19. The non-transitory computer-readable medium of claim 18, further comprising processor-executable instructions configured to cause one or more processors to generate the target video data based on the set of source video frames and the source audio data by:
generating a plurality of mouth region images for the user corresponding to the source audio data based on the set of training image features in the latent space using the trained decoder model;
blending the plurality of mouth region images with the set of source video frames respectively iteratively to generate a set of target video frames; and
synchronizing the set of target video frames and the source audio data to generate the target video data.

20. The non-transitory computer-readable medium of claim 17, further comprising processor-executable instructions configured to cause one or more processors to:
receive a text script from a user input device associated with a client device during the video conference; and
generate the source audio data based on the text script using a trained text-to-speech model.
